(19) United States
(12) Patent Application Publication
(10) Pub. No.: US 2024/0031873 A1
(43) Pub. Date: Jan. 25, 2024

(54) HANDLING DEACTIVATED SCG UPON SUSPEND/RESUME

(71) Applicant: Telefonaktiebolaget LM Ericsson (PUBL), Stockholm (SE)

(72) Inventors: Icaro Leonardo Da Silva, SOLNA (SE); Stefan Wager, ESPOO (FI)

(21) Appl. No.: 18/251,268

(22) PCT Filed: Nov. 2, 2021
(86) PCT No.: PCT/IB2021/060132

§ 371 Date: May 1, 2023

Related U.S. Application Data
(60) Provisional application No. 63/108,711, filed on Nov. 2, 2020.

(51) Int. Cl. H04W 28/20; H04W 76/16; H04W 76/27

(52) U.S. Cl. CPC H04W 28/20; H04W 76/16; H04W 76/27

(57) ABSTRACT

According to some embodiments, a method is performed by a wireless device for configuring a first cell group and a second cell group. The first cell group is associated with an operational mode and the second cell group is associated with an operational mode. The method comprises: transmitting a request to resume operation from an inactive or idle state; receiving an indication to transition to a connected state; determining an operational mode associated with the second cell group; and transitioning to the connected state. The indication to transition to the connected state further comprises an operational mode value for the second cell group, and determining the operational mode associated with the second cell group comprises setting the operational mode value of the second cell group to the operational mode value in the indication to transition to the connected state.

### TECHNICAL FIELD

Embodiments of the present disclosure are directed to wireless communications and, more particularly, to handling of a deactivated secondary cell group (SCG) upon suspend or resume.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Some wireless communication networks include a feature referred to as dual connectivity (DC). Dual connectivity is a mode of operation where a user equipment (UE) is configured to use the radio resource of two distinct schedulers, located in two eNBs namely Master eNB and Secondary eNB. Multiple radio access technology (RAT) dual connectivity (MR-DC) is s the general term given to a range of dual connectivity configuration options, largely associated with fifth generation (5G) networks. For example, the master eNB may be a 5G new radio (NR) gNB and the secondary node may be a long term evolution (LTE) eNB, or vice versa.

To improve network energy efficiency and UE battery life for UEs in MR-DC, some networks may include efficient secondary cell group (SCG)/SCell activation/deactivation. This can be particularly important for MR-DC configurations with NR SCG, because in some cases NR UE power consumption may be 3 to 4 times higher than LTE.

Third Generation Partnership Project (3GPP) has specified the concepts of dormant SCell (in LTE) and dormancy like behavior of an SCell (for NR). In LTE, when an SCell is in the dormant state, like in the deactivated state, the UE does not need to monitor the corresponding physical downlink control channel (PDCCH) or physical downlink shared channel (PDSCH) and cannot transmit in the corresponding uplink. However, different from the deactivated state, the UE is required to perform and report channel quality indicator (CQI) measurements. A physical uplink control channel (PUCCH) SCell (SCell configured with PUCCH) cannot be in the dormant state.

FIG. 1 illustrates dormancy like behavior for secondary cells in NR. In NR, dormancy like behavior for SCells is realized using the concept of dormant bandwidth parts (BWPs). One dormant BWP, which is one of the dedicated BWPs configured by the network via radio resource control (RRC) signaling, can be configured for an SCell. If the active BWP of the activated SCell is a dormant BWP, the UE stops monitoring PDCCH on the SCell but continues performing CSI measurements, automatic gain control (AGC) and beam management, if configured.

Downlink control information (DCI) is used to control entering/leaving the dormant BWP for one or more SCell(s) or one or more SCell group(s), and it is sent to the special cell (sPCell) of the cell group that the SCell belongs to (i.e., PCell in case the SCell belongs to the MCG and PSCell if the SCell belongs to the SCG). The SpCell (i.e., PCell of PSCell) and PUCCH SCell cannot be configured with a dormant BWP.

Only SCells, however, can be put to put in dormant state (in LTE) or operate in dormancy like behavior (NR). Also, only SCells can be put into the deactivated state in both LTE and NR. Thus, if the UE is configured with MR-DC, it is not possible to fully benefit from the power saving options of dormant state or dormancy like behavior as the PSCell cannot be configured with that feature.

One solution may be releasing (for power savings) and adding (when traffic demands requires) the SCG on an as needed basis. However, traffic is likely to be bursty, and adding and releasing the SCG involves a significant amount of RRC signaling and inter-node messaging between the MN and the SN, which causes considerable delay.

3GPP Release 16 (Rel-16) investigated putting the PSCell in dormancy, also referred to as SCG Suspension. Some preliminary agreements included that the UE supports network-controlled suspension of the SCG in RRC_CONNECTED. The UE supports at most one SCG configuration, suspended or not suspended, and in RRC_CONNECTED upon addition of the SCG, the SCG can be either suspended or not suspended by configuration.

Some solutions have been proposed, but these have different problems. For example, one option proposes that the gNB can instruct the UE to suspend SCG transmissions when no data traffic is expected to be sent in the SCG so that the UE keeps the SCG configuration but does not use it for power saving purposes. Signaling to suspend SCG could be based on DCI/MAC-CE/RRC signaling, but no details were provided regarding the configuration from the gNB to the UE. Additionally, different from the defined behavior for SCell(s), a PSCell may be associated to a different network node (e.g., a gNodeB operating as Secondary Node).

SCG power saving in Release 17 (Rel-17) may include one or more of the following procedures. The UE may start to operate the PSCell in dormancy, e.g., switch the PSCell to a dormant BWP. The network considers the PSCell in dormancy and at least stops transmitting PDCCH for the UE in the PSCell and SCells.

The UE may deactivate the PSCell like SCell deactivation. The network considers the PSCell as deactivated and at least stops transmitting PDCCH for the UE in the PSCell and SCells).

The UE may operate the PSCell in long DRX. SCG DRX can be switched off from the MN (e.g., via MCG RRC, MAC CE or DCI) when the need arises (e.g., downlink data arrival for SN terminated SCG bearers).

The UE may suspend its operation with the SCG (e.g., suspending bearers associated with the SCG, like SCG MN-/SN-terminated bearers), but keep the SCG configuration stored (referred to as Stored SCG). The network side may include different alternatives such as the SN storing the SCG as the UE does, or the SN releasing the SCG context of the UE to be generated again upon resume (e.g., with the support from the MN that is the node storing the SCG context for the UE whose SCG is suspended).

Though the power saving aspect is so far discussed from the SCG point of view, it is likely that similar approaches may be used on the MCG as well (e.g., the MCG may be suspended or in long DRX, while data communication is happening only via the SCG).

There currently exist certain challenges. For example, the network may determine to suspend an RRC connection for a UE operating in MR-DC (e.g., configured with a Secondary Cell Group—SCG and with a Master Cell Group—MCG), so the UE transitions from RRC_CONNETED to RRC_INACTIVE. 3GPP Rel-15 defines that the UE releases MR-DC configurations upon entering RRC_INACTIVE (though it was rather modeled as an MR-DC release upon the initiation to resume defined in TS 38.331, 5.3.13.2), as follows:

*************************************************************************

### Reception of the RRCRelease by the UE

The UE shall:

[ . . . ]
1> if the RRCRelease includes suspendConfig:
   2> apply the received suspendConfig;
   2> reset MAC and release the default MAC Cell Group configuration, if any;
   2> re-establish RLC entities for SRB1;
   2> if the RRCRelease message with suspendConfig was received in response to an RRCResumeRequest or an RRCResumeRequest1:
      3> stop the timer T319 if running;
      3> in the stored UE Inactive AS context:
         4> replace the K_{gNB} and K_{RRCint} keys with the current K_{gNB} and K_{RRCint} keys;
         4> replace the C-RNTI with the temporary C-RNTI in the cell the UE has received the RRCRelease message;
         4> replace the cellIdentity with the cellIdentity of the cell the UE has received the RRCRelease message;
         4> replace the physical cell identity with the physical cell identity of the cell the UE has received the RRCRelease message;
   2> else:
      3> store in the UE Inactive AS Context the current K_{gNB} and K_{RRCint} keys, the ROHC state, the stored QoS flow to DRB mapping rules, the C-RNTI used in the source PCell, the cellIdentity and the physical cell identity of the source PCell, and all other parameters configured except for the ones within ReconfigurationWithSync and servingCellConfigCommonSlB;
   2> suspend all SRB(s) and DRB(s), except SRB0;
   2> indicate PDCP suspend to lower layers of all DRBs;
   [ . . . ]
   2> enter RRC_INACTIVE and perform cell selection as specified in TS 38.304;
1> else
   2> perform the actions upon going to RRC_IDLE as specified in 5.3.11, with the release cause ‘other’.
   [ . . . ]
      RRC connection resume

### General

FIG. 2 is a flow diagram illustrating a successful RRC connection resume (reproduction of TS 38.331 FIG. 5.3.13.1-1).

The purpose of this procedure is to resume a suspended RRC connection, including resuming SRB(s) and DRB(s) or perform an RNA update.

Initiation

The UE initiates the procedure when upper layers or AS (when responding to RAN paging or upon triggering RNA updates while the UE is in RRC_INACTIVE) requests the resume of a suspended RRC connection.

The UE shall ensure having valid and up to date essential system information before initiating this procedure.

Upon initiation of the procedure, the UE shall:
[ . . . ]
1> if the UE is in NE-DC or NR-DC:
   2> release the MR-DC related configuration from the UE Inactive AS context, if stored;
[ . . . ]
1> initiate transmission of the RRCResumeRequest message or RRCResumeRequest1.
[ . . . ]

### MR-DC Release

### The UE Shall:

1> as a result of MR-DC release triggered by E-UTRA or NR:
   2> release SRB3, if established;
   2> release measConfig associated with SCG;
   2> if the UE is configured with NR SCG:
      3> release the SCG configuration;
   2> else if the UE is configured with E-UTRA SCG:
      3> release the SCG configuration to release the E-UTRA SCG;
         *************************************************************************

Rel-16 includes an enhancement for A UE operating in MR-DC that is suspended to RRC_INACTIVE, the UE stores the SCG configurations so that they can be restored and resumed upon resume procedure. The UE in Rel-16 stores the spCellConfigCommon within ReconfigurationWithSync of the NR PSCell (if configured).

Another change in resume initiation in Rel-16 was that the UE only releases MR-DC if it does not support maintaining SCG configuration upon connection resumption. When the UE restores the context, it restores the MR-DC configuration, including the SCG configuration (as defined up to Rel-16).

Another change is that RRCResume can include the field mrdc-SecondaryCellGroup possibly set to nr-SCG, so that an SCG RRC Reconfiguration can include the reconfiguration with sync for the SCG to be resumed (or added). This is needed to trigger a random access procedure with the PSCell that is being resumed. This is shown as follows:

*************************************************************************

### Reception of the RRCRelease by the UE

The UE shall:

[ . . . ]
1> if the RRCRelease includes suspendConfig:
   2> apply the received suspendConfig;
   2> remove all the entries within VarConditionalReconfig, if any;
   2> for each measId, if the associated reportConfig has a reportType set to condTriggerConfig:
      3> for the associated reportConfigId:
         4> remove the entry with the matching reportConfigId from the reportConfigList within the VarMeasConfig;
      3> if the associated measObjectId is only associated to a reportConfig with reportType set to condTriggerConfig:
         4> remove the entry with the matching measObjectId from the measObjectList within the VarMeasConfig;
      3> remove the entry with the matching measId from the measIdList within the VarMeasConfig;
   2> reset MAC and release the default MAC Cell Group configuration, if any;
   2> re-establish RLC entities for SRB1;
   2> if the RRCRelease message with suspendConfig was received in response to an RRCResumeRequest or an RRCResumeRequest1:
      [ . . . ]
   2> else:
      3> store in the UE Inactive AS Context the current K_{gNB} and K_{RRCint} keys, the ROHC state, the stored QoS flow to DRB mapping rules, the C-RNTI used in the source PCell, the cellIdentity and the physical cell identity of the source PCell, the spCellConfigCommon within ReconfigurationWithSync of the NR PSCell (if configured) and all other parameters configured except for:
         parameters within ReconfigurationWithSync of the PCell;
         parameters within ReconfigurationWithSync of the NR PSCell, if configured;
         parameters within MobilityControllnfoSCG of the E-UTRA PSCell, if configured;
         servingCellConfigCommonSIB;
[ . . . ]
   2> enter RRC_INACTIVE and perform cell selection as specified in TS 38.304;
1> else
   2> perform the actions upon going to RRC_IDLE, with the release cause ‘other’.
[ . . . ]

### RRC Connection Resume

### General

The purpose of this procedure is to resume a suspended RRC connection, including resuming SRB(s) and DRB(s) or perform an RNA update.

[ . . . ]

Initiation

[ . . . ]
Upon initiation of the procedure, the UE shall:
[ . . . ]
1> if the UE is in NE-DC or NR-DC:
   2> if the UE does not support maintaining SCG configuration upon connection resumption:
      3> release the MR-DC related configurations from the UE Inactive AS context, if stored;
[ . . . ]
1> initiate transmission of the RRCResumeRequest message or RRCResumeRequest1.
   Actions related to transmission of RRCResumeRequest or RRCResumeRequest1 message
   The UE shall set the contents of RRCResumeRequest or RRCResumeRequest1 message as follows:
[ . . . ]
1> restore the RRC configuration, RoHC state, the stored QoS flow to DRB mapping rules and the K_{gNB} and K_{RRCint} keys from the stored UE Inactive AS context except for the following:
   masterCellGroup;
   mrdc-SecondaryCellGroup, if stored; and
   pdcp-Config;
   [ . . . ]
1> submit the selected message RRCResumeRequest or RRCResumeRequest1 for transmission to lower layers.

NOTE 2: Only DRBs with previously configured UP ciphering shall resume ciphering.
[ . . . ]

### Reception of the RRCResume by the UE

The UE shall:
[ . . . ]
1> if the RRCResume includes the fullConfig:
   2> perform the full configuration procedure;
1> else:
   [ . . . ]
   2> if the RRCResume does not include the restoreSCG:
      3> release the MR-DC related configurations from the UE Inactive AS context, if stored;
   2> restore the masterCellGroup, mrdc-SecondaryCellGroup, if stored, and pdcp-Config from the UE Inactive AS context;
   [ . . . ]
1> if the RRCResume includes the mrdc-SecondaryCellGroup:
   2> if the received mrdc-SecondaryCellGroup is set to nr-SCG:
      3> perform the RRC reconfiguration for the RRCReconfiguration message included in nr-SCG;
   2> if the received mrdc-SecondaryCellGroup is set to eutra-SCG:
      3> perform the RRC connection reconfiguration as specified in TS 36.331, clause
5.3.5.3 for the RRCConnectionReconfiguration message included in eutra-SCG;
   [ . . . ]
1> enter RRC_CONNECTED;
[ . . . ]
1> set the content of the of RRCResumeComplete message as follows:
   [ . . . ]
   2> if the RRCResume message includes the mrdc-SecondaryCellGroupConfig with mrdc-SecondaryCellGroup set to eutra-SCG:
      3> include in the eutra-SCG-Response the E-UTRA RRCConnectionReconfigurationComplete message in accordance with TS 36.331 clause 5.3.5.3;
   2> if the RRCResume message includes the mrdc-SecondaryCellGroupConfig with mrdc-SecondaryCellGroup set to nr-SCG:
      3> include in the nr-SCG-Response the SCG RRCReconfigurationComplete message;
         [ . . . ]
1> submit the RRCResumeComplete message to lower layers for transmission;
1> the procedure ends.
   [ . . . ]

| | |
|---|---|
| RRCResume-v1610-IEs : := | SEQUENCE { |
| [...] | |
| restoreSCG-r16 | ENUMERATED {true} |
| OPTIONAL, -- Need N | |
| mrdc-SecondaryCellGroup-r16 | CHOICE { |
| nr-SCG-r16 | OCTET STRING |
| (CONTAINING RRCReconfiguration), | |
| eutra-SCG-r16 | OCTET STRING |
| } | |
| OPTIONAL, -- Cond RestoreSCG | |
| [...] | |
| } | |
| -- TAG-RRCRESUME-STOP | |
| -- ASN1STOP | |

RRCResume-IEs field descriptions

mrdc-SecondaryCellGroup
Includes an RRC message for SCG configuration in NR-DC or NE-DC.
For NR-DC (nr-SCG), mrdc-SecondaryCellGroup contains the
RRCReconfiguration message as generated (entirely) by SN gNB. In this
version of the specification, the RRC message only includes fields
secondaryCellGroup, with at least reconfigurationWithSync, and
measConfig.
For NE-DC (eutra-SCG), mrdc-SecondaryCellGroup includes the E-UTRA
RRCConnectionReconfiguration message as specified in TS 36.331. In
this version of the specification, the E-UTRA RRC message only include
the field scg-Configuration with at least mobilityControlInfoSCG.
restoreSCG
Indicates that the UE shall restore the SCG configurations from the UE
Inactive AS Context, if stored.

*************************************************************************

With the introduction in Rel-17 of a deactivated SCG, the network may still determine to suspend the UE to RRC_INACTIVE. Upon suspension (i.e., reception of an RRCRelease with suspendConfig), if the SCG is activated the same behavior as in Rel-16 could be adopted, as to some extent, in Rel-16 the SCG is always activated as long as it is configured. However, with the Rel-17 feature, the SCG may be deactivated when the UE receives an RRCRelease with suspendConfig. Moreover, when the UE initiates a resume procedure, it is unclear how the SCG (that was deactivated when the UE was suspended) should be handled.

At the network side, inter-node procedures are also unclear. In Rel-16 the source gNodeB that determines to suspend a UE to RRC_INACTIVE may indicate that to the SN (where SCG is configured). However, with the Rel-17 feature, the SCG may be in deactivated mode of operation, so it is unclear whether and how the SN is to be notified upon suspension of the connection.

### SUMMARY

Based on the description above, certain challenges currently exist with handling a deactivated secondary cell group (SCG) upon suspend or resume. Certain aspects of the present disclosure and their embodiments may provide solutions to these or other challenges.

Particular embodiments include a method at a wireless terminal, also referred to as a user equipment (UE). The UE is capable of supporting a deactivated secondary cell group (SCG). The method comprises receiving a configuration to operate in multiple radio access technology dual connectivity (MR-DC). The configuration comprises the configuration of a secondary cell group. Upon suspend to RRC_INACTIVE, the method comprises receiving a message indicating the transition to RRC_INACTIVE and performing at least one of the following actions:
A) Store the state information (or mode of operation) for the secondary cell group as part of the UE Inactive AS Context.
B) Consider the state information of the secondary cell group as “activated” when entering RRC_INACTIVE (e.g., by setting UE variable to activated) or during the resume procedure (e.g., upon reception of an RRCResume message).
C) Consider the state information of the secondary cell group as “deactivated” when entering RRC_INACTIVE (e.g., by setting UE variable to activated) or during the resume procedure (e.g., upon reception of an RRCResume message).
D) Consider the state information of the secondary cell group according to a configuration indication in the message transitioning the UE to RRC_INACTIVE, e.g., a field that may be set to “activated” or “deactivated” when entering RRC_INACTIVE.

Upon resume to RRC_CONNECTED, the method comprises initiating a resume procedure and performing at least one of the following actions:
A) Restore the state information (mode of operation) for the SCG as part of the UE Inactive AS Context.
B) Consider the state information of the secondary cell group as “activated” during the resume procedure (e.g., upon reception of an RRCResume message).
C) Consider the state information of the secondary cell group as “deactivated” during the resume procedure (e.g., upon reception of an RRCResume message).
D) Consider the state information of the secondary cell group according to a configuration indication in the message transitioning the UE to RRC_CONNECTED, e.g., a field that may be set to “activated” or “deactivated” when entering RRC_CONNECTED.

Some embodiments include a method at a network node operating as a master node (MN) for a wireless terminal capable of operating in MR-DC. The method comprises: sending a request to a SN to setup a secondary cell group for the UE, where the secondary cell group can be set to either “activated” or “deactivated”; receiving a response from the SN including the configuration comprising a secondary cell group, e.g., a secondary cell group (SCG) configuration; and configuring the UE to operate in MR-DC. The configuration comprises the configuration of a secondary cell group, e.g., a SCG configuration.

The method further comprises: determining to transition the UE to RRC_INACTIVE; sending an indication to the SN that the UE will be suspended, where the secondary cell group can be set to either “activated” or “deactivated”; receiving a response from the SN including the configuration comprising a secondary cell group, e.g., a SCG configuration; and transmitting a message to the UE for transitioning the UE to RRC_INACTIVE, e.g., RRCRelease with suspendConfig. The message includes state information of the secondary cell group, e.g., a configuration field set as either “activated” or “deactivated”.

The method further comprises: determining to resume the UE's connection, e.g., to transition the UE to RRC_CONNECTED; sending a request to the SN that the UE will be resumed, where the secondary cell group can be set to either “activated” or “deactivated”; receiving a response from the SN including the configuration comprising a secondary cell group, e.g., a SCG configuration; and transmitting a message to the UE for transitioning the UE to RRC_CONNECTED, e.g., RRCResume. The message includes state information of the secondary cell group, e.g., a configuration field set as either “activated” or “deactivated”.

Some embodiments include a method at network node operating as a secondary node (SN) for a wireless terminal operating in MR-DC. The method comprises receiving a request from a MN to configure the UE to operate in MR-DC and generating a configuration comprising the configuration of a secondary cell group, e.g., a SCG configuration. The secondary cell group can be set to either “activated” or “deactivated”. The method further comprises: sending a response to the MN including the secondary cell group configuration; receiving an indication from the MN that the UE will be suspended and that the secondary cell group shall be set to either “activated” or “deactivated”; and sending a response to the MN, including the configuration comprising a secondary cell group, e.g., a SCG configuration.

According to some embodiments, a method is performed by a wireless device for configuring a first cell group and a second cell group. The first cell group is associated with an operational mode and the second cell group is associated with an operational mode. The method comprises receiving an indication to transition to an idle or inactive state and performing one or more of the following operations: storing the operational mode associated with the second cell group, or releasing the operational mode associated with the second cell group. The method further comprises transitioning to the idle or inactive state.

In particular embodiments, storing the operational mode associated with the second cell group comprises storing it in an access stratum context for the wireless device. Storing the operational mode may comprise storing a value of activated, deactivated, or a current operational mode value of the second cell group.

In particular embodiments, the indication to transition to an idle or active state further comprises an operational mode value for the second cell group, and storing the operational mode associated with the second cell group comprises storing the operational mode from the indication to transition to the idle or inactive state.

In particular embodiments, the method comprises: transmitting a request to resume operation; determining an indication to transition to a connected state; determining an operational mode associated with the second cell group; and transitioning to the connected state.

In particular embodiments, determining the operational mode associated with the second cell group comprises restoring the operational mode of the second cell group from an access stratum context for the wireless device. Determining the operational mode associated with the second cell group may comprise setting an operational mode value of the second cell group to activated or deactivated.

In particular embodiments, the indication to transition to the connected state further comprises an operational mode value for the second cell group, and determining the operational mode associated with the second cell group comprises setting the operational mode value of the second cell group to the operational mode value in the indication to transition to the connected state.

In particular embodiments, the wireless device is operating in dual connectivity with the first cell group and the second cell group, and the first cell group comprises a master cell group and the second cell group comprises a secondary cell group. In other embodiments, the first cell group comprises a secondary cell group and the second cell group comprises a master cell group.

According to some embodiments, a wireless device comprises processing circuitry operable to perform any of the wireless device methods described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method is performed by a first network node in a first cell group serving a wireless device. The wireless device is also configured with a second cell group and wherein the first cell group is associated with an operational mode and the second cell group is associated with an operational mode. The method comprises: determining to transition the wireless device to an idle or inactive state; transmitting an indication to a second network node in the second cell group that the wireless device will transition to an idle or inactive state; and transmitting an indication to the wireless device to transition to an idle or inactive state. The indication comprises an operational mode associated with the second cell group.

In particular embodiments, the method further comprises receiving from the second network node an operational mode associated with the second cell group.

In particular embodiments, the method further comprises: determining to transition the wireless device to a connected state; transmitting an indication to the second network node in the second cell group that the wireless device will transition to a connected state; and transmitting an indication to the wireless device to transition to a connected state, the indication comprising an operational mode associated with the second cell group.

In particular embodiments, the indication comprising an operational mode of the second cell group further comprises an indication of one of an activated state, a deactivated state, or a stored state.

According to some embodiments, a network node comprises processing circuitry operable to perform any of the network node methods described above.

Also disclosed is a computer program product comprising a non-transitory computer readable medium storing computer readable program code, the computer readable program code operable, when executed by processing circuitry to perform any of the methods performed by the network node described above.

Certain embodiments may provide one or more of the following technical advantages. For example, an advantage of particular embodiments is that there is not a mismatch between a UE's SCG state and the network's SCG state. At the network side, procedures are clear when the connection is resumed: PSCell's SCG is either activated or deactivated. In addition, because the state of the SCG may be included in RRC Resume, a signaling optimization is achieved (i.e., the UE does not need to wait for an RRC Reconfiguration (after the resume procedure) to receive an indication of the state of the SCG.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates dormancy like behavior for secondary cells in new radio (NR);

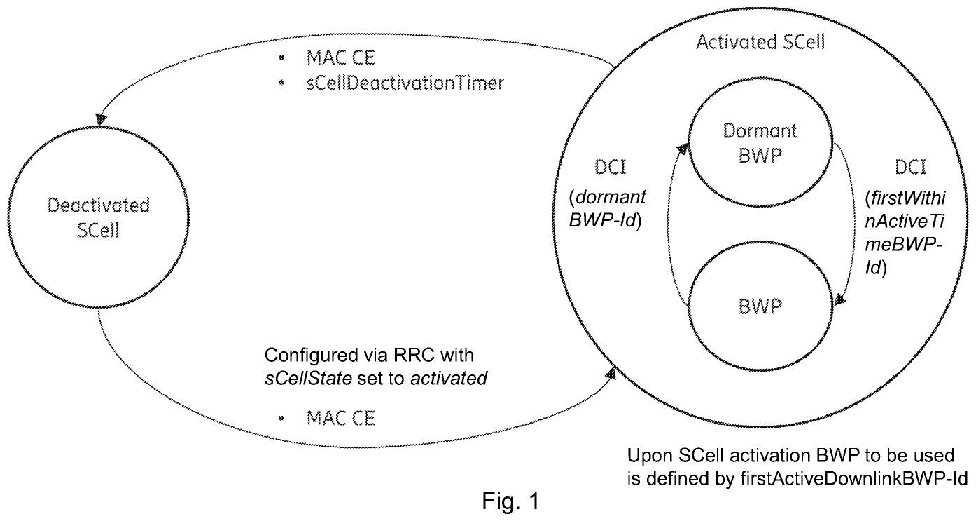

FIG. 2 is a flow diagram illustrating a successful RRC connection resume;

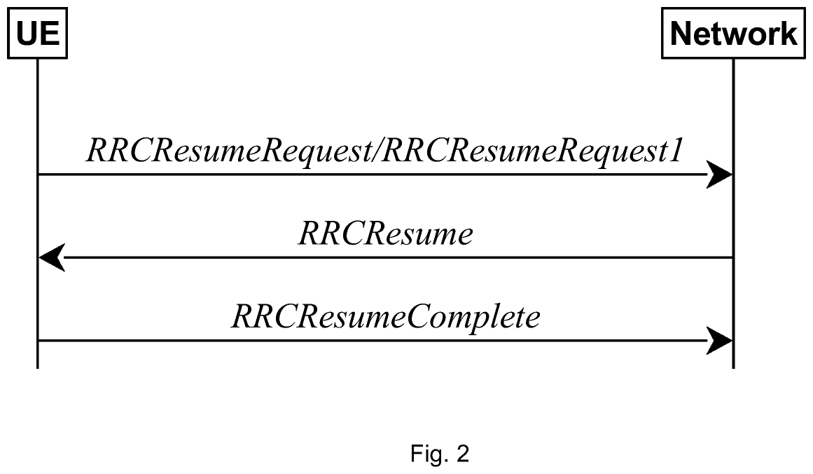

FIG. 3 is a block diagram illustrating an example wireless network;

FIG. 4 illustrates an example user equipment, according to certain embodiments;

FIG. 5 is flowchart illustrating an example method in a wireless device, according to certain embodiments; and

FIG. 6 is flowchart illustrating an example method in a network node, according to certain embodiments.

### DETAILED DESCRIPTION

As described above, certain challenges currently exist with handling a deactivated secondary cell group (SCG) upon suspend or resume. Certain aspects of the present disclosure and their embodiments may provide solutions to these or other challenges.

Particular embodiments ensure that there is not a mismatch between a user equipment (UE) SCG state and a network SCG state. At the network side, a PSCell SCG is either activated or deactivated. Additionally, including the state of the SCG in radio resource control (RRC) Resume results in a signaling optimization.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

The terms suspended SCG, SCG in power saving mode, or deactivated SCG are used interchangeably. The term suspended SCG may also be referred to as deactivated SCG, inactive SCG, or dormant SCG. The terms resumed SCG, SCG in normal operating mode and SCG in non-power saving mode are used interchangeably. The term resumed SCG may also be referred to as activated SCG or active SCG. The operation of the SCG operating in resumed or active mode may also be referred to as normal SCG operation or legacy SCG operation. Examples of operations are UE signal reception/transmission procedures, e.g. radio link monitoring (RLM) measurements, reception of signals, transmission of signals, etc.

The terms state information or mode of operation are used interchangeably. For example, SCG deactivated can be considered as a state information for the SCG, or a mode of operation of the SCG. For example, activated SCG can be considered as a state information for the SCG, or a mode of operation of the SCG.

The text mostly refers and show examples wherein the secondary cell group is a SCG for a UE configured with dual connectivity (e.g. MR-DC). In that case, when the text refers to measurements on the SCG or measurements associated with the SCG are performed, that may correspond to performing measurements on a cell of the SCG, e.g., PSCell.

The text describes terms like SCG and PSCell as one of the cells associated with the SCG. This may be, for example, a PSCell as defined in new radio (NR) specifications (e.g., RRC TS 38.331), defined as a special cell (SpCell) of the SCG, or a primary SCG Cell (PSCell), as follows:
Secondary Cell Group: For a UE configured with dual connectivity, the subset of serving cells comprising of the PSCell and zero or more secondary cells (SCells).
Special Cell: For dual connectivity operation the term special cell refers to the PCell of the MCG or the PSCell of the SCG, otherwise the term special cell refers to the PCell.
Primary SCG Cell (PSCell): For dual connectivity operation, the SCG cell in which the UE performs random access when performing the Reconfiguration with Sync procedure.

For the sake of brevity, the text mostly refers to and describes examples where the secondary cell group is a SCG that can be suspended for a UE configured with dual connectivity (e.g., MR-DC). However, the embodiments and examples are equally applicable when the secondary cell group is a master cell group (MCG) for a UE configured with dual connectivity (e.g., MR-DC) where the MCG may be suspended while the SCG is operating in normal mode.

The term RRC_INACTIVE is used in the text to refer to the RRC state defined in TS 38.331. However, the embodiments and examples are not limited to that and refer to any state where the connection of the UE is suspended, e.g. RRC_IDLE with stored context.

The terms suspended SCG, SCG in power saving mode, or deactivated SCG are used to refer to at least the SpCell of the SCG, for example, the PSCell. Thus, when it is stated that the SCG is deactivated, it means that at least the PSCell is deactivated, and when it is stated that the SCG is activated, it means that at least the PSCell is activated and the SCG SCell(s) are activated.

Particular embodiments comprise a method at a wireless terminal operating in MR-DC. The method comprises receiving a configuration comprising a configuration of a secondary cell group, e.g. a SCG configuration. In some embodiments, the configuration is received within an RRCReconfiguration message (e.g., via the MN/MCG), including the mrdc-SecondaryCellGroupConfig that can be set to an SCG RRC container (e.g., set to nr-SCG), which can be an RRCReconfiguration (denoted RRCReconfiguration**) for the SCG configuration. Upon reception, the UE configures the SCG (e.g., applies RRCReconfiguration**) and perform actions accordingly;

The method further comprises receiving an indication that the secondary cell group (e.g., the SCG) is to be deactivated, i.e., the UE considers the secondary cell group as deactivated. In some embodiments, the indication is received via the MN. In some embodiments, the indication is received via the SN. In some embodiments, the indication comprises an RRC message (e.g., RRCReconfiguration) including a field and/or information element (IE) indicating that the secondary cell group is deactivated.

Upon receiving the indication, the UE operates with the secondary cell group according to a deactivated mode of operation. The deactivated mode of operation may include at least one of the following actions.

The UE stops monitoring physical downlink control channel (PDCCH), core resource sets (CORESETs), and/or control channels. The UE performs radio resource measurement (RRM) according to SCG/SN MeasConfig, but either with less strict requirements (e.g., in terms of accuracy, periodicity of measurements) and/or a limited number of measurements (e.g., only serving cell measurements, only serving frequencies, etc.). The UE performs radio link monitoring (RLM) measurements with less strict requirements (e.g., in terms of accuracy, periodicity of measurements, fewer beams to be monitored, only a subset of reference signals, etc.). The UE stops transmitting sounding reference signals (SRS). The UE may set a UE variable associated to the mode of operation (state) of the secondary cell group to “deactivated.” The state variable may be used in later procedures where actions are performed based on the secondary cell group being “deactivated” or not.

The UE may be suspended to RRC_INACTIVE. The method further comprises receiving a message indicating the transition to RRC_INACTIVE and performing at least one of the following actions.

In some embodiments, the UE stores the state information (or mode of operation) for the secondary cell group as part of the UE Inactive AS Context. In particular embodiments, the stored state information is restored (and used) when the UE resume the connection. For example, the UE may receive a RRCResume message that may have an optional indication of the state/mode of operation of an SCG. If an indication in RRCResume is not included, the UE may consider the state stored when transitioned to RRC_INACTIVE, that is restored upon resume, as the state of the SCG after Resume. If the indication in RRCResume is included, the indication may override the restored indication. In particular embodiments, the state information is only stored if the SCG state is considered as “deactivated.” A reason is that if it is activated, the UE behavior the same as in legacy Rel-16, and there is no need to act differently.

In some embodiments, the UE considers the state information of the secondary cell group as “activated” when entering RRC_INACTIVE (e.g., by setting UE variable to activated) or during the resume procedure (e.g., upon reception of an RRCResume message). In particular embodiments, during the suspend procedure (e.g., reception of RRC Release) the UE does not store the SCG state information (e.g., discards that information, a UE variable associated, etc.).

In some embodiments, the UE consider the state information of the secondary cell group as “deactivated” when entering RRC_INACTIVE (e.g., by setting UE variable to deactivated) or during the resume procedure (e.g., upon reception of an RRCResume message). In particular embodiments, during the suspend procedure (e.g., reception of RRC Release) the UE does not store the SCG state information (e.g., discards that information, a UE variable associated, etc.). The SCG is then set to deactivated only during the resume procedure (both the PSCell and the SCells of the SCG).

In some embodiments, the message comprises an RRC Release message (e.g., RRCRelease defined in TS 38.331) including a suspend configuration (e.g., suspendConfig as defined in TS 38.331);

The UE may resume to RRC_CONNECTED. The method further comprises initiating a resume procedure and performing at least one of the following actions.

In some embodiments, the UE restores the state information (mode of operation) for the SCG as part of the UE Inactive AS Context. In particular embodiments, the stored state information is restored (and used) when the UE tries to resume the connection. For example, the RRCResume message the UE receives may include an optional indication of the state/mode of operation of an SCG. If the indication is not included in RRCResume, the UE may consider the state stored when transitioned to RRC_INACTIVE, that is restored upon resume, as the state of the SCG after Resume. If the indication in RRCResume is included, it may override the restored indication.

In particular embodiments, during resume initiation, before transmission of an RRC Resume Request (e.g., RRCResumeRequest or RRCResumeRequest1), the UE does not restore the state information for the secondary cell group, e.g., does not restore modeOfOperation-SCG, if stored. In particular embodiments, the state information for the SCG (e.g., modeOfOperation-SCG) may be considered as part of the mrdc-SecondaryCellGroup. Thus, if it is indicated that mrdc-SecondaryCellGroup is to be restored or not restored, it includes the state information.

In particular embodiments, the procedure relies on the existing indication in RRCResume restoreSCG. If the RRCResume does not include the restoreSCG, then the UE releases the MR-DC related configurations from the UE Inactive AS context, if stored.

Otherwise, the UE restores the masterCellGroup, mrdc-SecondaryCellGroup, if stored, modeOfOperation-SCG, if stored, and pdcp-Config from the UE Inactive AS context. If RRCResume includes modeOfOperation for the SCG set to “deactivated,” the UE configures lower layers to consider the restored SCG to be in deactivated state. If RRCResume includes modeOfOperation for the SCG set to “activated,” the UE configures lower layers to consider the restored SCG to be in activated state. Otherwise, the UE configures lower layers to consider the restored SCG to be in the restored state in modeOfOperation-SCG.

In some embodiments, the UE consider the state information of the secondary cell group as “activated” during the resume procedure (e.g., upon reception of an RRCResume message). In particular embodiments, during the resume procedure, the UE configures lower layers to consider the restored SCG (e.g., the SpCell of the SCG (if any)) to be in activated state. For example, if the SCG state is deactivated, the UE changes to activated; if the SCG state is already activated, UE does not change the state.

In particular embodiments, the handling of the SpCell of the SCG is the opposite of the handling of the SCell(s) of the SCG (SCG SCell(s)), that are considered deactivated upon resume (so network is to activate them if it wants to).

In particular embodiments, the handling of the SpCell of the SCG is the same as the handling of the SCell(s) of the SCG (SCG SCell(s)). In one option, the SCG SpCell and SCells are considered activated upon resume (so network is to deactivate them if it wants to). In another option, the SCG SpCell and SCells are considered deactivated upon resume (so network is to activate them if it wants to).

In particular embodiments, during resume procedure, a state information for the SCG may be included to indicate a deactivated state (considering that the network knows that the SCG, if configured, is activated by default during resume). Otherwise the UE operates according to legacy operation, i.e., SCG considered activated depending on further information included in RRC Resume (e.g., reconfiguration with sync for the SCG). The logic is that if the network wants to deactivate the SCG, the network includes in the SCG RRC Reconfiguration an indication to deactivate the SCG, i.e., the network can apply the Rel-17 feature for SCG deactivation if it wants to.

In particular embodiments, the RRCResume includes the mrdc-SecondaryCellGroup, wherein the received mrdc-SecondaryCellGroup is set to nr-SCG, and the UE perform the RRC reconfiguration for the RRCReconfiguration message included in nr-SCG, wherein the RRCReconfiguration message includes an indication of the SCG state/mode of operation (e.g., deactivated), so that the UE configures the lower layers to consider the SCG (e.g., the SpCell of the SCG (if any)) to be in a deactivated state.

In some embodiments, the UE considers the state information of the secondary cell group as “deactivated” during the resume procedure (e.g., upon reception of an RRCResume message). In particular embodiments, during the resume procedure, the UE configures lower layers to consider the restored SCG (e.g., the SpCell of the SCG (if any)) to be in deactivated state. For example, if the SCG state is activated, the UE changes it to deactivated. If the SCG state is already deactivated, the UE does not change the state.

In particular embodiments, the handling of the SpCell of the SCG is the same as the handling of the SCell(s) of the SCG (SCG SCell(s)), that are considered deactivated upon resume (so the network is to activate them if it wants to).

If the network wants to activate the SCG, the network includes in the SCG RRC Reconfiguration an indication to activate the SCG, with the Reconfiguration with Sync and random access configuration for the UE to access the PSCell upon activation. If the network does not want to activate the SCG, and its PSCell, the network does not include the indication of the state (and the UE is considered as deactivated). This makes the handling of SCG SCell(s) and PSCell similar because both would be considered as deactivated when the UE resumes the stored SCG. Thus, the network needs to be proactive if it wants to activate the SCG (PSCell and SCG SCell(s)).

In particular embodiments, during resume procedure, a state information for the SCG may be included to indicate an activated state, otherwise the SCG is deactivated. This can be modeled by the UE either considering SCG activated when entering RRC_INACTIVE, or when attempting to resume (e.g., during resume initiation or upon reception of RRCResume).

Some embodiments may impact the RRC specifications (TS 38.331). One example is illustrated below, wherein the RRCReconfiguration message contains an explicit indication of the mode of operation for the secondary cell group (e.g., the Secondary Cell Group in this example). It is included as part of the CellGroupConfig IE, because that mode of operation is applicable for the entire cell group, e.g., the field modeOfOperation of IE ENUMERATED {deactivated, activated}. Upon receiving the indication that the UE is to consider the SCG deactivated, the UE sets a UE variable (e.g., modeOfOperation-SCG) to the value indicated in the message, for example modeOfOperation-SCG is set to “deactivated.”

***************************************************************************

### Reception of an RRCReconfiguration by the UE

The UE shall perform the following actions upon reception of the RRCReconfiguration, or upon execution of the conditional reconfiguration (CHO or CPC):
[ . . . ]
1> if the RRCReconfiguration includes the secondaryCellGroup:
   2> perform the cell group configuration for the SCG;
      [ . . . ]
      5.3.5.5 Cell Group configuration

### 5.3.5.5.1 General

[ . . . ]
The UE performs the following actions based on a received CellGroupConfig IE:
1> if modeOfOperation is included:
   2> if modeOfOperation is set to “deactivated”;
      3> set the UE variable modeOfOperation-SCG to “deactivated”;
      3> consider the SCG as suspended/deactivated;
1> if the CellGroupConfig contains the spCellConfig with reconfigurationWithSync:
   [ . . . ]
   2> perform Reconfiguration with sync;
   [ . . . ]

| | |
|---|---|
| RRCReconfiguration-IEs : := | SEQUENCE { |
| radioBearerConfig | RadioBearerConfig |
| OPTIONAL, -- Need M | |
| secondaryCellGroup | OCTET STRING |

(CONTAINING CellGroupConfig) OPTIONAL, -- Cond SCG

| | |
|---|---|
| measConfig | MeasConfig |
| OPTIONAL, -- Need M | |
| lateNonCriticalExtension | OCTET STRING |
| OPTIONAL, | |
| nonCriticalExtension | RRCReconfiguration- |
| | v1530-IEs |
| OPTIONAL | |
| } | |
| . . . | |
| -- Configuration of one Cell-Group: | |
| CellGroupConfig : := | SEQUENCE { |
| . . . | |
| modeOfOperation | ENUMERATED |
| {deactivated, activated}, | |
| spCellConfig | SpCellConfig |
| OPTIONAL, -- Need M | |
| . . . | |
| } | |

-- Serving cell specific MAC and PHY parameters for a SpCell:

| | |
|---|---|
| SpCellConfig : := | SEQUENCE { |
| ... | |
| reconfigurationWithSync | ReconfigurationWithSync |
| OPTIONAL, -- Cond ReconfWithSync | |
| ... | |
| } | |

[ . . . ]
***************************************************************************

Regarding the actions upon suspend and resume in RRC specifications, a first example is shown below:

***************************************************************************

### Reception of the RRCRelease by the UE

The UE shall:
[ . . . ]
1> if the RRCRelease includes suspendConfig:
   2> apply the received suspendConfig;
      [ . . . ]
   2> if the RRCRelease message with suspendConfig was received in response to an RRCResumeRequest or an RRCResumeRequest1:
      [ . . . ]
   2> else:
      3> store in the UE Inactive AS Context the current K_{gNB} and K_{RRCint} keys, the ROHC state, the stored QoS flow to DRB mapping rules, the C-RNTI used in the source PCell, the cellIdentity and the physical cell identity of the source PCell, the spCellConfigCommon within ReconfigurationWithSync of the NR PSCell (if configured), the UE variable modeOfOperation-SCG (if configured), and all other parameters configured except for:
         parameters within ReconfigurationWithSync of the PCell;
         parameters within ReconfigurationWithSync of the NR PSCell, if configured;
         parameters within MobilityControllnfoSCG of the E-UTRA PSCell, if configured;
         servingCellConfigCommonSIB;
[ . . . ]
   2> enter RRC_INACTIVE and perform cell selection as specified in TS 38.304;
1> else
   2> perform actions upon going to RRC_IDLE with the release cause ‘other’.
[ . . . ]

### 5.3.13 RRC Connection Resume

### 5.3.13.1 General

[ . . . ]
   The purpose of this procedure is to resume a suspended RRC connection, including resuming SRB(s) and DRB(s) or perform an RNA update.

[ . . . ]

### Initiation

[ . . . ]
Upon initiation of the procedure, the UE shall:
[ . . . ]
1> initiate transmission of the RRCResumeRequest message or RRCResumeRequest1.
   Actions related to transmission of RRCResumeRequest or RRCResumeRequest1 message
   The UE shall set the contents of RRCResumeRequest or RRCResumeRequest1 message as follows:
[ . . . ]
1> restore the RRC configuration, RoHC state, the stored QoS flow to DRB mapping rules and the K_{gNB} and K_{RRCint} keys from the stored UE Inactive AS context except for the following:
   masterCellGroup;
   modeOfOperation-SCG, if stored;
   mrdc-SecondaryCellGroup, if stored; and
   pdcp-Config;
   [ . . . ]
1> submit the selected message RRCResumeRequest or RRCResumeRequest1 for transmission to lower layers.
NOTE 2: Only DRBs with previously configured UP ciphering shall resume ciphering.
   [ . . . ]

### Reception of the RRCResume by the UE

The UE shall:
[ . . . ]
1> if the RRCResume includes the fullConfig:
   2> perform the full configuration procedure;
1> else:
   [ . . . ]
   2> if the RRCResume does not include the restoreSCG:
      3> release the MR-DC related configurations from the UE Inactive AS context, if stored;
   2> restore the masterCellGroup, mrdc-SecondaryCellGroup, if stored, modeOfOperation-SCG, if stored, and pdcp-Config from the UE Inactive AS context;
      3> if RRCResume includes modeOfOperationSCG for the SCG set to “deactivated”, configure lower layers to consider the restored SCG to be in deactivated state;
      3> if RRCResume includes modeOfOperationSCG for the SCG set to “activated”, configure lower layers to consider the restored SCG to be in activated state;
      3> else:
         4> configure lower layers to consider the restored SCG to be in the restored state in modeOfOperation-SCG;
   2> configure lower layers to consider the restored MCG and SCG SCell(s) (if any) to be in deactivated state;
1> discard the UE Inactive AS context;
   [ . . . ]
1> if the RRCResume includes the mrdc-SecondaryCellGroup:
   2> if the received mrdc-SecondaryCellGroup is set to nr-SCG:
      3> perform the RRC reconfiguration for the RRCReconfiguration message included in nr-SCG;
   2> if the received mrdc-SecondaryCellGroup is set to eutra-SCG:
      3> perform the RRC connection reconfiguration as specified in TS 36.331, clause 5.3.5.3 for the RRCConnectionReconfiguration message included in eutra-SCG;
   [ . . . ]
1> enter RRC_CONNECTED;
[ . . . ]
1> set the content of the of RRCResumeComplete message as follows:
   [ . . . ]
   2> if the RRCResume message includes the mrdc-SecondaryCellGroupConfig with mrdc-SecondaryCellGroup set to eutra-SCG:
      3> include in the eutra-SCG-Response the E-UTRA RRCConnectionReconfigurationComplete message in accordance with TS 36.331 clause 5.3.5.3;
   2> if the RRCResume message includes the mrdc-SecondaryCellGroupConfig with mrdc-SecondaryCellGroup set to nr-SCG:
      3> include in the nr-SCG-Response the SCG RRCReconfigurationComplete message;
         [ . . . ]
1> submit the RRCResumeComplete message to lower layers for transmission;
1> the procedure ends. [ . . . ]

| | |
|---|---|
| RRCResume-v1610-IEs : := | SEQUENCE { |
| [...] | |
| restoreSCG-r16 | ENUMERATED {true} |
| OPTIONAL, -- Need N | |
| modeOfOperationSCG-r17 | ENUMERATED |
| {activated, deactivated} | OPTIONAL, -- |
| Need S | |
| mrdc-SecondaryCellGroup-r16 | CHOICE { |
| nr-SCG-r16 | OCTET STRING |
| (CONTAINING RRCReconfiguration), | |
| eutra-SCG-r16 | OCTET STRING |
| } | |
| OPTIONAL, -- Cond RestoreSCG | |
| [...] | |
| } | |
| -- TAG-RRCRESUME-STOP | |
| -- ASN1STOP | |

Another alternative ASN.1 code is to have that mode of operation within Cell Group Config. In the case of the SCG, that may be within the CellGroupConfig for the SCG that is within the nr-SCG-r16 container within the mrdc-SecondaryCellGroup (as that contains an RRCReconfiguration with a secondaryCellGroup configuration, of IE CellGroupConfig).

***************************************************************************

Regarding the actions upon suspend and resume in RRC specifications, a second example is shown below (e.g., SCG always activated upon resume, if network wants it can deactivate the SCG in RRCResume).

***************************************************************************

### Reception of the RRCRelease by the UE

The UE shall:
[ . . . ]
1> if the RRCRelease includes suspendConfig:
   2> apply the received suspendConfig;
      [ . . . ]
   2> if the RRCRelease message with suspendConfig was received in response to an RRCResumeRequest or an RRCResumeRequest1:
      [ . . . ]
   2> else:
      3> store in the UE Inactive AS Context the current K_{gNB} and K_{RRCint} keys, the ROHC state, the stored QoS flow to DRB mapping rules, the C-RNTI used in the source PCell, the cellIdentity and the physical cell identity of the source PCell, the spCellConfigCommon within ReconfigurationWithSync of the NR PSCell (if configured) and all other parameters configured except for:
         parameters within ReconfigurationWithSync of the PCell;
         parameters within ReconfigurationWithSync of the NR PSCell, if configured;
         parameters within MobilityControllnfoSCG of the E-UTRA PSCell, if configured;
         servingCellConfigCommonSIB;
[ . . . ]
   2> suspend all SRB(s) and DRB(s), except SRB0;
   2> indicate PDCP suspend to lower layers of all DRBs;
      [ . . . ]
   2> indicate the suspension of the RRC connection to upper layers;
   2> enter RRC_INACTIVE and perform cell selection as specified in TS 38.304;
1> else
   2> perform the actions upon going to RRC_IDLE with the release cause ‘other’.

### RRC Connection Resume

### General

[ . . . ]
   The purpose of this procedure is to resume a suspended RRC connection, including resuming SRB(s) and DRB(s) or perform an RNA update.

[ . . . ]

### Initiation

[ . . . ]
Upon initiation of the procedure, the UE shall:
[ . . . ]
1> initiate transmission of the RRCResumeRequest message or RRCResumeRequest1.
   Actions related to transmission of RRCResumeRequest or RRCResumeRequest1 message
   The UE shall set the contents of RRCResumeRequest or RRCResumeRequest1 message as follows:
[ . . . ]
1> restore the RRC configuration, RoHC state, the stored QoS flow to DRB mapping rules and the K_{gNB} and K_{RRCint} keys from the stored UE Inactive AS context except for the following:
   masterCellGroup;
   mrdc-SecondaryCellGroup, if stored; and
   pdcp-Config;

[ . . . ]
1> submit the selected message RRCResumeRequest or RRCResumeRequest1 for transmission to lower layers.
NOTE 2: Only DRBs with previously configured UP ciphering shall resume ciphering.
[ . . . ]

### Reception of the RRCResume by the UE

The UE shall:
[ . . . ]
1> if the RRCResume includes the fullConfig:
   2> perform the full configuration procedure;
1> else:
   [ . . . ]
   2> if the RRCResume does not include the restoreSCG:
      3> release the MR-DC related configuration from the UE Inactive AS context, if stored;
   2> restore the masterCellGroup, mrdc-SecondaryCellGroup, if stored, and pdcp-Config from the UE Inactive AS context;
   2> configure lower layers to consider the restored MCG and SCG SCell(s) (if any) to be in deactivated state;
   2> configure lower layers to consider the restored SpCell of the SCG (if any) to be in activated state;
NOTE: This is done when the UE supports the Rel-17 feature where the SCG can be deactivated. If the UE does not support the Rel-17 feature where the SCG can be deactivated, the SCG (in particular the SpCell of the SCG) is anyways considered as activated, as that is the only known state for the SCG for these UEs not supporting the Rel-17 feature.
   [ . . . ]
1> discard the UE Inactive AS context;
   [ . . . ]
1> if the RRCResume includes the mrdc-SecondaryCellGroup:
   2> if the received mrdc-SecondaryCellGroup is set to nr-SCG:
      3> perform the RRC reconfiguration for the RRCReconfiguration message included in nr-SCG;
NOTE: The RRCReconfiguration message included in nr-SCG can include an indication of the SCG state/mode of operation (e.g., deactivated);
   2> if the received mrdc-SecondaryCellGroup is set to eutra-SCG:
      3> perform the RRC connection reconfiguration as specified in TS 36.331, clause
5.3.5.3 for the RRCConnectionReconfiguration message included in eutra-SCG;
   [ . . . ]
1> enter RRC_CONNECTED;
[ . . . ]
1> set the content of the of RRCResumeComplete message as follows:
   [ . . . ]
   2> if the RRCResume message includes the mrdc-SecondaryCellGroupConfig with mrdc-SecondaryCellGroup set to eutra-SCG:
      3> include in the eutra-SCG-Response the E-UTRA RRCConnectionReconfigurationComplete message in accordance with TS 36.331 clause 5.3.5.3;
      2> if the RRCResume message includes the mrdc-SecondaryCellGroupConfig with mrdc-SecondaryCellGroup set to nr-SCG:
      3> include in the nr-SCG-Response the SCG RRCReconfigurationComplete message;
         [ . . . ]
1> submit the RRCResumeComplete message to lower layers for transmission;
1> the procedure ends.
   [ . . . ]

| | |
|---|---|
| RRCResume-v1610-IEs : := | SEQUENCE { |
| [...] | |
| restoreSCG-r16 | ENUMERATED {true} |
| OPTIONAL, -- Need N | |
| modeOfOperationSCG-r17 | ENUMERATED |
| {activated, deactivated} | OPTIONAL, -- |
| Need S | |
| mrdc-SecondaryCellGroup-r16 | CHOICE { |
| nr-SCG-r16 | OCTET STRING |
| (CONTAINING RRCReconfiguration), | |
| eutra-SCG-r16 | OCTET STRING |
| } | |
| OPTIONAL, -- Cond RestoreSCG | |
| [...] | |
| } | |
| -- TAG-RRCRESUME-STOP | |
| -- ASN1STOP | |

Another alternative ASN.1 code is to have that mode of operation within Cell Group Config. In the case of the SCG, that may be within the CellGroupConfig for the SCG that is within the nr-SCG-r16 container within the mrdc-SecondaryCellGroup (as that contains an RRCReconfiguration with a secondaryCellGroup configuration, of IE CellGroupConfig).

***************************************************************************

Regarding the actions upon suspend and resume in RRC specifications, a second example is shown below (e.g., SCG always activated upon resume, if network wants it can deactivate the SCG in RRCResume).

***************************************************************************

### Reception of the RRCRelease by the UE

The UE shall:
[ . . . ]
1> if the RRCRelease includes suspendConfig:
   2> apply the received suspendConfig;
      [ . . . ]
   2> if the RRCRelease message with suspendConfig was received in response to an RRCResumeRequest or an RRCResumeRequest1:
      [ . . . ]
   2> else:
      3> store in the UE Inactive AS Context the current K_{gNB} and K_{RRCint} keys, the ROHC state, the stored QoS flow to DRB mapping rules, the C-RNTI used in the source PCell, the cellIdentity and the physical cell identity of the source PCell, the spCellConfigCommon within ReconfigurationWithSync of the NR PSCell (if configured) and all other parameters configured except for:
         parameters within ReconfigurationWithSync of the PCell;
         parameters within ReconfigurationWithSync of the NR PSCell, if configured;
         parameters within MobilityControllnfoSCG of the E-UTRA PSCell, if configured;
         servingCellConfigCommonSlB;
[ . . . ]
   2> suspend all SRB(s) and DRB(s), except SRB0;
   2> indicate PDCP suspend to lower layers of all DRBs;
      [ . . . ]
   2> indicate the suspension of the RRC connection to upper layers;
   2> enter RRC_INACTIVE and perform cell selection as specified in TS 38.304;
1> else
   2> perform actions upon going to RRC_IDLE with the release cause ‘other’.

### RRC Connection Resume

### General

[ . . . ]
   The purpose of this procedure is to resume a suspended RRC connection, including resuming SRB(s) and DRB(s) or perform an RNA update.
[ . . . ]

### Initiation

[ . . . ]
Upon initiation of the procedure, the UE shall:
[ . . . ]
1> initiate transmission of the RRCResumeRequest message or RRCResumeRequest1.
   Actions related to transmission of RRCResumeRequest or RRCResumeRequest1 message
   The UE shall set the contents of RRCResumeRequest or RRCResumeRequest1 message as follows:
[ . . . ]
1> restore the RRC configuration, RoHC state, the stored QoS flow to DRB mapping rules and the K_{gNB} and K_{RRCint} keys from the stored UE Inactive AS context except for the following:
   masterCellGroup;
   mrdc-SecondaryCellGroup, if stored; and
   pdcp-Config;
   [ . . . ]
1> submit the selected message RRCResumeRequest or RRCResumeRequest1 for transmission to lower layers.
NOTE 2: Only DRBs with previously configured UP ciphering shall resume ciphering.
   [ . . . ]

### Reception of the RRCResume by the UE

The UE shall:
[ . . . ]
1> if the RRCResume includes the fullConfig:
   2> perform the full configuration procedure;
1> else:
   [ . . . ]
   2> if the RRCResume does not include the restoreSCG:
      3> release the MR-DC related configurations from the UE Inactive AS context, if stored;
   2> restore the masterCellGroup, mrdc-SecondaryCellGroup, if stored, and pdcp-Config from the UE Inactive AS context;
   2> configure lower layers to consider the restored MCG and SCG SCell(s) (if any) and the restored SpCell of the SCG (if any) to be in deactivated state;
   2> configure lower layers to consider the restored SpCell of the SCG (if any) to be in deactivated state;
NOTE: The deactivation of the PSCell upon resume is done when the UE supports the Rel-17 feature where the SCG can be deactivated.
   [ . . . ]
1> discard the UE Inactive AS context;
   [ . . . ]
1> if the RRCResume includes the mrdc-SecondaryCellGroup:
   2> if the received mrdc-SecondaryCellGroup is set to nr-SCG:
      3> perform the RRC reconfiguration for the RRCReconfiguration message included in nr-SCG;
NOTE: The RRCReconfiguration message included in nr-SCG can include an indication of the SCG state/mode of operation (e.g., activated);
   2> if the received mrdc-SecondaryCellGroup is set to eutra-SCG:
      3> perform the RRC connection reconfiguration as specified in TS 36.331, clause 5.3.5.3 for the RRCConnectionReconfiguration message included in eutra-SCG;
   [ . . . ]
1> enter RRC_CONNECTED;
[ . . . ]
1> set the content of the of RRCResumeComplete message as follows:
   [ . . . ]
   2> if the RRCResume message includes the mrdc-SecondaryCellGroupConfig with mrdc-SecondaryCellGroup set to eutra-SCG:
      3> include in the eutra-SCG-Response the E-UTRA RRCConnectionReconfigurationComplete message in accordance with TS 36.331 clause 5.3.5.3;
   2> if the RRCResume message includes the mrdc-SecondaryCellGroupConfig with mrdc-SecondaryCellGroup set to nr-SCG:
      3> include in the nr-SCG-Response the SCG RRCReconfigurationComplete message;
         [ . . . ]
1> submit the RRCResumeComplete message to lower layers for transmission;
1> the procedure ends.
   [ . . . ]

| | |
|---|---|
| RRCResume-v1610-IEs : := | SEQUENCE { |
| [...] | |
| restoreSCG-r16 | ENUMERATED {true} |
| OPTIONAL, -- Need N | |
| modeOfOperationSCG-r17 | ENUMERATED |
| {activated, deactivated} | OPTIONAL, -- |
| Need S | |
| mrdc-SecondaryCellGroup-r16 | CHOICE { |
| nr-SCG-r16 | OCTET STRING |
| (CONTAINING RRCReconfiguration), | |
| eutra-SCG-r16 | OCTET STRING |
| } | |
| OPTIONAL, -- Cond RestoreSCG | |
| [...] | |
| } | |
| -- TAG-RRCRESUME-STOP | |
| -- ASN1STOP | |

Another alternative ASN.1 code is to have that mode of operation within Cell Group Config. In the case of the SCG, that may be within the CellGroupConfig for the SCG that is within the nr-SCG-r16 container within the mrdc-SecondaryCellGroup (as that contains an RRCReconfiguration with a secondaryCellGroup configuration, of IE CellGroupConfig).

Some embodiments comprise a method at a network node operating as Master Node (MN) for a wireless terminal operating in MR-DC. The method comprises configuring the UE to operate in MR-DC. The configuration comprises the configuration of a secondary cell group, e.g., a SCG configuration.

The method further comprises transmitting to the UE an indication that the secondary cell group (e.g., the SCG) is to be deactivated, i.e., the UE considers the secondary cell group as deactivated. In particular embodiments, the MN transmits to the SN an indication that the secondary cell group (e.g., the SCG) is to be deactivated (if MN-initiated deactivation of the SCG). In particular embodiments, the MN receives from the SN an indication that the secondary cell group (e.g., the SCG) is to be deactivated (if this is an SN-initiated deactivation of the SCG).

The method further comprises determining to transition the UE to RRC_INACTIVE. The MN node may determine, after inactivity is reported from the SN and also MN resources show no activity, to transition the UE to RRC_INACTIVE. Resumption to RRC_CONNECTED may take place after activity is reported from the SN for SN terminated bearers.

In some embodiments, actions are performed to keep the higher layer MR-DC NG-RAN resources established for UEs in RRC_INACTIVE, including NG and Xn interface C-plane, U-plane and bearer contexts established while lower layer MCG and SCG resources are released, for the case the SCG is deactivated. The NG-RAN stores the cell group configuration for MCG to apply delta signaling at resume, as specified in TS 38.331 and, in some embodiments, the state or mode of operation of the SCG.

In particular embodiments, the MN transmits to the SN an indication that the UE is to transition to RRC_INACTIVE, e.g., an SN Modification Request message over XnAP interface. The indication may include a request to release lower layers; or upon reception at the SN, the SN UE context is identified, and the SN releases the lower layers. The indication may include a request to suspend the lower layers. Upon reception at the SN, the SN UE context is identified, and the SN suspends the lower layers, except if the SCG is deactivated (which means the SCG is already suspended and its lower layers).

Upon reception at the SN, the SN UE context is identified and the state of the SCG is considered to be at least one of the options: (a) the state that is stored (e.g. deactivated, activated); (b) Activated; (c) Deactivated; and (d) a state that is set in the indication, e.g., in the SN Modification Request. If the state is considered activated, the SN does not operate accordingly until the connection is to be resumed.

In particular embodiments, the MN receives from the SN an acknowledgement of the indication, e.g., a SN Modification Request Acknowledgement message over XnAP interface.

The method further comprises transmitting a message to the UE for transitioning the UE to RRC_INACTIVE, e.g., RRCRelease with suspendConfig, and determining to resume the UE's connection. e.g., to transition the UE to RRC_CONNECTED.

In particular embodiments, the resume is determined by the reception from the SN of an Activity notification indication. In particular embodiments, the MN transmits to the SN an indication that the UE is to transition to RRC_CONNECTED, e.g., a SN Modification Request message over XnAP interface. The indication may include a request to re-establish the lower layers; or upon reception at the SN, the SN UE context is identified, and the SN re-establishes the lower layers, e.g., generate a new configuration for the SCG's lower layers.

The indication may include a request to resume the lower layers. Upon reception at the SN, the SN UE context is identified, and the SN resumes the lower layers (stored in the context).

Upon reception of the resume request, the SN may determine the state/mode of operation of the SCG at least according to one of the following: (a) the state that is stored (e.g., deactivated, activated); (b) Activated; (c) Deactivated; and (d) determines the SCG state (mode of operation) and includes in the SN/SCG configuration to be provided to the UE, e.g., deactivated SCG, activated SCG, possibly depending on the expected activity on the SCG, for example in the SN RRC Reconfiguration (to be set as an nr-SCG, for example, in the MR-DC configuration to the provided to the UE in RRCResume, to be generated by the MN).

The method further comprises transmitting an RRCResume to the UE.

Some embodiments comprise a method at a network node operating as Secondary Node (SN) for a wireless terminal operating in MR-DC. The method comprises receiving a request from a MN to configure a UE to operate in MR-DC, and generating a configuration comprising the configuration of a secondary cell, e.g., a SCG configuration.

Consider that the secondary cell group (e.g., the SCG) is to be deactivated, i.e., that the UE considers the secondary cell group as deactivated. In some embodiments, the SN receives from the MN an indication that the secondary cell group (e.g., the SCG) is to be deactivated (if MN-initiated deactivation of the SCG). In some embodiments, the SN transmits to the MN an indication that the secondary cell group (e.g., the SCG) is to be deactivated (if this is an SN-initiated deactivation of the SCG).

The UE may transition to RRC_INACTIVE. In some embodiments, the SN receives from the MN an indication that the UE is to transition to RRC_INACTIVE, e.g., a SN Modification Request message over XnAP interface.

The indication may include a request to release lower layers; or upon reception at the SN, the SN UE context is identified, and the SN releases the lower layers. The indication may include a request to suspend the lower layers. Upon reception at the SN, the SN UE context is identified, and the SN suspends the lower layers, except if the SCG is deactivated (which means the SCG is already suspended and its lower layers).

Upon reception at the SN, the SN UE context is identified and the state of the SCG is considered to be at least one of the options: (a) the state that is stored (e.g., deactivated, activated); (b) Activated; (c) Deactivated; (d) a state that is set in the indication, e.g., in the SN Modification Request. If the state is considered activated, the SN does not operate accordingly until the connection is to be resumed.

In some embodiments, the SN transmits to the MN an acknowledgement of the indication, e.g., An SN Modification Request Acknowledgement message over XnAP interface.

The method further comprises performing one of the following actions. In some embodiments, the SN may transmit to the MN an Activity notification indication, e.g., if there is upcoming data on an SN-terminated bearer.

In some embodiments, the SN receives from the MN an indication that the UE is to transition to RRC_CONNECTED, e.g., a SN Modification Request message over XnAP interface. The indication may include a request to re-establish the lower layers; or upon reception at the SN, the SN UE context is identified, and the SN re-establishes the lower layers, e.g., generate a new configuration for the SCG's lower layers. The indication may include a request to resume the lower layers. Upon reception at the SN, the SN UE context is identified, and the SN resumes the lower layers (stored in the context).

Upon reception of the indication, the SN may determine the state/mode of operation of the SCG at least according to one of the following: (a) the state that is stored (e.g., deactivated, activated); (b) Activated; (c) Deactivated; and (d) determines the SCG state (mode of operation) and includes in the SN/SCG configuration to be provided to the UE, e.g., deactivated SCG, activated SCG, possibly depending on the expected activity on the SCG, for example in the SN RRC Reconfiguration (to be set as an nr-SCG, for example, in the MR-DC configuration to the provided to the UE in RRCResume, to be generated by the MN).

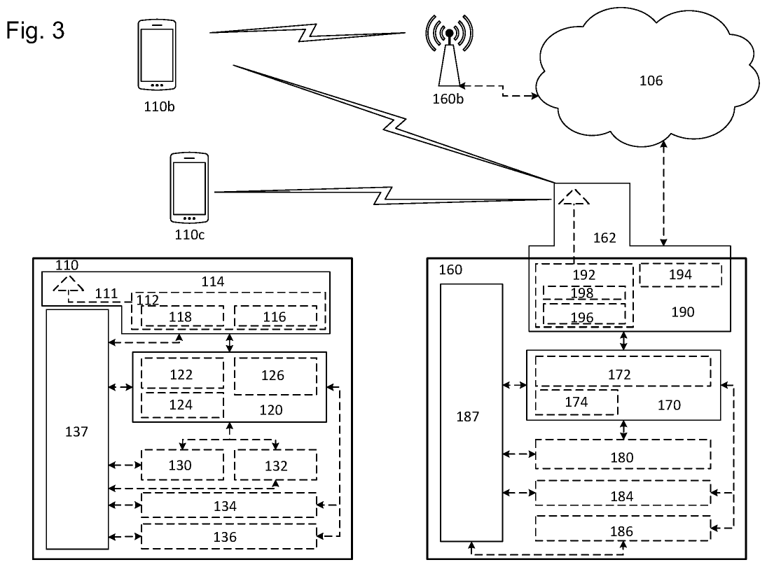

In FIG. 3, network node 160 includes processing circuitry 170, device readable medium 180, interface 190, auxiliary equipment 184, power source 186, power circuitry 187, and antenna 162. Although network node 160 illustrated in the example wireless network of FIG. 3 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 3 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 3. For simplicity, the wireless network of FIG. 3 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

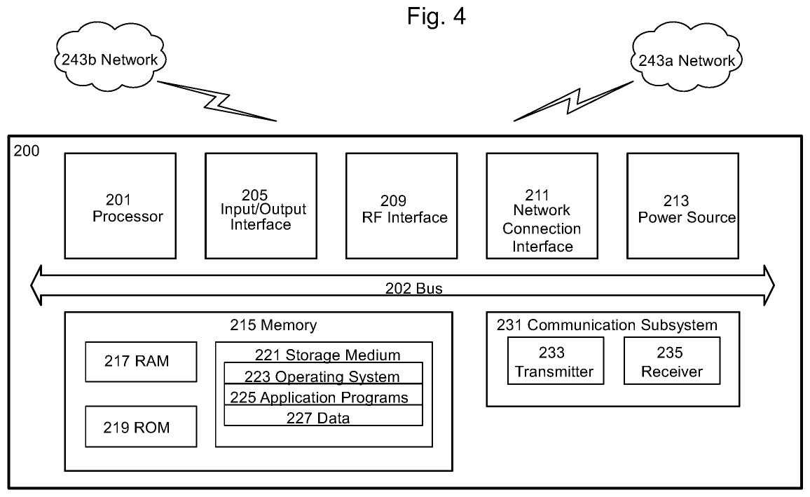

FIG. 4 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 4, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 4 is a UE, the components discussed herein are equally applicable to a WD, and vice-versa.

In FIG. 4, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 4, or only a subset of the components. The level of integration between the components may vary from one UE to another UE. Further, certain UEs may contain multiple instances of a component, such as multiple processors, memories, transceivers, transmitters, receivers, etc.

In FIG. 4, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 4, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 4, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

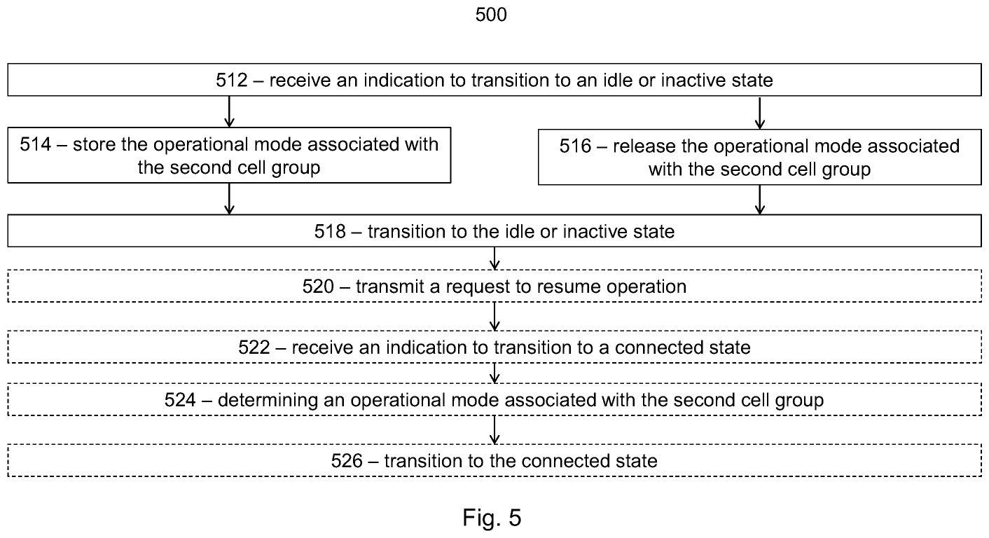

FIG. 5 is a flowchart illustrating an example method in a wireless device, according to certain embodiments. In particular embodiments, one or more steps of FIG. 5 may be performed by wireless device 110 described with respect to FIG. 3. The wireless device is configured with a first cell group and a second cell group (e.g., MR-DC). The first cell group is associated with an operational mode (e.g., activated, deactivated) and the second cell group is associated with an operational mode, which can be different.

The method begins at step 512, where the wireless device (e.g., wireless device 110) receives an indication to transition to an idle or inactive state. For example, the wireless device may receive an RRC message suspending the wireless device to RRC_INACTIVE or RRC_IDLE.

The wireless device may perform one or more of the following operations. At step 514, the wireless device stores the operational mode associated with the second cell group. The wireless device may later use the stored state when resuming operation. In some embodiments, the wireless device stores the current operational mode of the second cell group. In some embodiments, the wireless device defaults the stored state to either activated or deactivated.

In particular embodiments, the indication to transition to an idle or active state further comprises an operational mode value (e.g., activated, deactivated) for the second cell group, and storing the operational mode associated with the second cell group comprises storing the operational mode from the indication to transition to the idle or inactive state.

In particular embodiments, storing the operational mode associated with the second cell group comprises storing it in an access stratum context for the wireless device.

Some embodiments may include step 516, where the wireless device releases or ignores the operational mode associated with the second cell group. For example, the wireless device may set an operational mode associated with the second cell group to a default value upon resume.

At step 518, the wireless device transitions to the idle or inactive state (e.g., RRC_INACTIVE, RRC_IDLE). When the wireless device is ready to transition out of the idle or inactive state, the method continues to step 520.

At step 520, the wireless device transmits a request to resume operation. For example, the wireless device may transmit a RRC Resume request to a network node, such as network node 120.

At step 522, the wireless device receives an indication to transition to a connected state. For example, the wireless device may receive an RRC message transitioning the wireless device to RRC_CONNECTED.

At step 524, the wireless device determines an operational mode (e.g., activated, deactivated) associated with the second cell group. In particular embodiments, determining the operational mode associated with the second cell group comprises restoring the operational mode of the second cell group from an access stratum context for the wireless device. Determining the operational mode associated with the second cell group may comprise setting an operational mode value of the second cell group to default value or activated or deactivated.

In particular embodiments, the indication to transition to the connected state further comprises an operational mode value for the second cell group, and determining the operational mode associated with the second cell group comprises setting the operational mode value of the second cell group to the operational mode value in the indication to transition to the connected state.

At step 526, the wireless device transitions to the connected state (e.g., RRC_CONNECTED).

In particular embodiments, the first cell group comprises a master cell group and the second cell group comprises a secondary cell group. In other embodiments, the first cell group comprises a secondary cell group and the second cell group comprises a master cell group.

Modifications, additions, or omissions may be made to method 500 of FIG. 5. Additionally, one or more steps in the method of FIG. 5 may be performed in parallel or in any suitable order. For example, in some cases the resume steps may be performed first. While particular examples are described with respect to each step of method 500, the steps may be performed according to any of the embodiments and examples described herein.

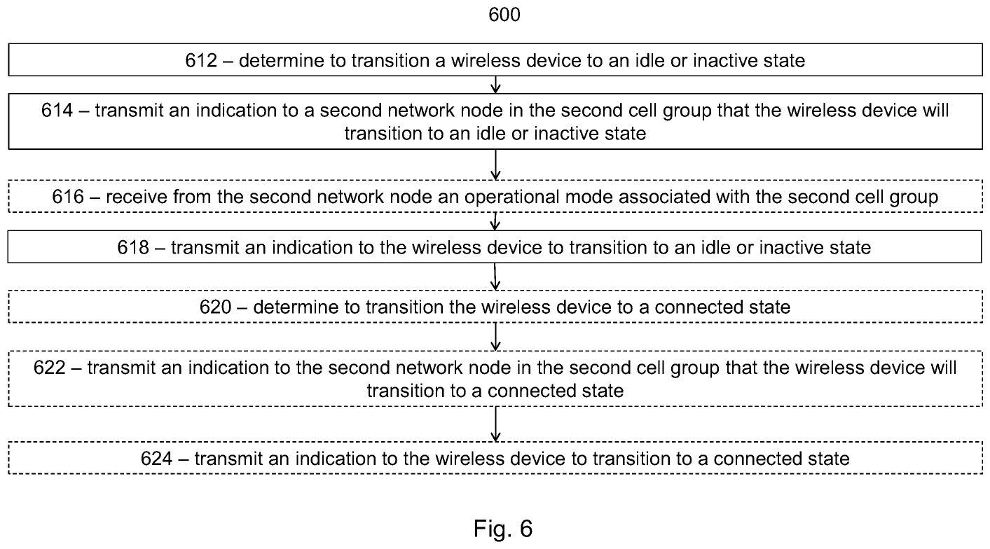

FIG. 6 is a flowchart illustrating an example method in a network node, according to certain embodiments. In particular embodiments, one or more steps of FIG. 6 may be performed by network node 160 described with respect to FIG. 3. The network node comprises a first network node in a first cell group serving a wireless device. The wireless device is also configured with a second cell group and the first cell group is associated with an operational mode and the second cell group is associated with an operational mode. The method begins at step 612, where the network node (e.g., network node 160) determines to transition the wireless device to an idle or inactive state (e.g., RRC_INACTIVE, RRC_IDLE).

At step 614, the network node transmits an indication to a second network node in the second cell group that the wireless device will transition to an idle or inactive state. Based on the indication, the second network node may perform any of the operations described herein.

In some embodiments, at step 616 the network node may receive from the second network node an operational mode associated with the second cell group. The network node may store the operational mode and/or use the operational mode when sending indications to the wireless device.

At step 618, the network node transmitting an indication to the wireless device to transition to an idle or inactive state. The indication comprises an operational mode associated with the second cell group.

At step 620, the network node determines to transition the wireless device to a connected state. For example, the network node may have data to send to the wireless device.

At step 622, the network node transmits an indication to the second network node in the second cell group that the wireless device will transition to a connected state. Based on the indication, the second network node may perform any of the operations described herein.

At step 644, the network node transmits an indication to the wireless device to transition to a connected state. The indication comprises an operational mode associated with the second cell group.

In particular embodiments, the indication comprising an operational mode of the second cell group further comprises an indication of one of an activated state, a deactivated state, or a stored state.

Modifications, additions, or omissions may be made to method 600 of FIG. 6. Additionally, one or more steps in the method of FIG. 6 may be performed in parallel or in any suitable order. For example, in some cases the resume steps may be performed first. While particular examples are described with respect to each step of method 600, the steps may be performed according to any of the embodiments and examples described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
ABS Almost Blank Subframe
ACK/NACK Acknowledgment/Non-acknowledgment
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CG Configured Grant
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality Information
C-RNTI Cell RNTI
CSI Channel State Information
DCCH Dedicated Control Channel
DCI Downlink Control Information
DFTS-OFDM Discrete Fourier Transform Spread OFDM
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
GERAN GSM EDGE Radio Access Network
GF Grant-Free
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MCS Modulation and Coding Scheme
MDT Minimization of Drive Tests
MIB Master Information Block
MME Mobility Management Entity
MO Monitoring Occasion
MS Monitoring Span
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR
Reference Signal Received Power
RSRQ Reference Signal Received Quality OR
Reference Symbol Received Quality
RSSI Received Signal Strength Indicator
RSTD Reference Signal Time Difference
SCH Synchronization Channel
SCell Secondary Cell
SDU Service Data Unit
SFN System Frame Number
SGW Serving Gateway
SI System Information
SIB System Information Block
SNR Signal to Noise Ratio
SON Self Optimized Network
SPS Semi-Persistent Scheduling
SUL Supplemental Uplink
SS Synchronization Signal
SSS Secondary Synchronization Signal
TDD Time Division Duplex
TDOA Time Difference of Arrival
TO Transmission Occasion
TOA Time of Arrival
TSS Tertiary Synchronization Signal
TTI Transmission Time Interval
UE User Equipment
UL Uplink
URLLC Ultra-Reliable and Low-Latency Communications
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network
WU Wake-up
WUG Wake-up Group
WUR Wake-up Radio/Wake-up Receiver
WUS Wake-up Signal/Wake-up Signaling

1. A method performed by a wireless device for configuring a first cell group and a second cell group, wherein the first cell group is associated with an operational mode and the second cell group is associated with an operational mode, the method comprising:
transmitting a request to resume operation from an inactive or idle state;
receiving an indication to transition to a connected state;
determining an operational mode associated with the second cell group; and
transitioning to the connected state.

2. The method of claim 1, wherein the indication to transition to the connected state further comprises an operational mode value for the second cell group, and determining the operational mode associated with the second cell group comprises setting the operational mode value of the second cell group to the operational mode value in the indication to transition to the connected state.

3.-11. (canceled)

12. A wireless device configurable with a first cell group and a second cell group, wherein the first cell group is associated with a first operational mode and the second cell group is associated with a second operational mode, the wireless device comprising processing circuitry operable to:
transmit a request to resume operation from an idle or inactive state;
receive an indication to transition to a connected state;
determine an operational mode associated with the second cell group; and
transition to the connected state.

13. The wireless device of claim 12, wherein the indication to transition to the connected state further comprises an operational mode value for the second cell group, and the processing circuitry is operable to determine the operational mode associated with the second cell group by setting the operational mode value of the second cell group to the operational mode value in the indication to transition to the connected state.

14. The wireless device of claim 12, wherein the processing circuitry is operable to determine the operational mode associated with the second cell group by restoring the operational mode of the second cell group from an access stratum context for the wireless device.

15. The wireless device of claim 12, wherein the processing circuitry is operable to determine the operational mode associated with the second cell group by setting an operational mode value of the second cell group to activated or deactivated.

16. The wireless device of claim 12, the processing circuitry further operable to:
receive an indication to transition to an idle or inactive state;
perform one or more of the following operations:
store the operational mode associated with the second cell group;
release the operational mode associated with the second cell group; and
transition to the idle or inactive state.

17. The wireless device of claim 16, wherein the processing circuitry is operable to store the operational mode associated with the second cell group by storing the operational mode associated with the second cell group in an access stratum context for the wireless device.

18. The wireless device of claim 16, wherein the processing circuitry is operable to store the operational mode associated with the second cell group by storing an operational mode value of activated or deactivated.

19. The wireless device of claim 16, wherein the processing circuitry is operable to store the operational mode associated with the second cell group by storing a current operational mode value of the second cell group.

20. The wireless device of claim 16, wherein the indication to transition to an idle or active state further comprises an operational mode value for the second cell group, and the processing circuitry is operable to store the operational mode associated with the second cell group by storing the operational mode from the indication to transition to the idle or inactive state.

21. The wireless device of claim 12, wherein the wireless device is operating in dual connectivity with the first cell group and the second cell group, and the first cell group comprises a master cell group and the second cell group comprises a secondary cell group.

22. The wireless device of claim 12, wherein the wireless device is operating in dual connectivity with the first cell group and the second cell group, and the first cell group comprises a secondary cell group and the second cell group comprises a master cell group.

23. A method performed by a first network node in a first cell group serving a wireless device, wherein the wireless device is also configured with a second cell group and wherein the first cell group is associated with an operational mode and the second cell group is associated with an operational mode, the method comprising:
determining to transition the wireless device to a connected state;
transmitting an indication to the second network node in the second cell group that the wireless device will transition to a connected state; and
transmitting an indication to the wireless device to transition to a connected state, the indication comprising an operational mode associated with the second cell group.

24.-28. (canceled)

29. A network node capable of operating in a first cell group serving a wireless device, wherein the wireless device is also configured with a second cell group and wherein the first cell group is associated with an operational mode and the second cell group is associated with an operational mode, the network node comprising processing circuitry operable to:
determine to transition the wireless device to a connected state;
transmit an indication to the second network node in the second cell group that the wireless device will transition to a connected state; and
transmit an indication to the wireless device to transition to a connected state, the indication comprising an operational mode associated with the second cell group.

30. The network node of claim 29, wherein the indication comprising an operational mode of the second cell group further comprises an indication of one of an activated state, a deactivated state, or a stored state.

31. The network node of claim 29, the processing circuitry further operable to:
determine to transition the wireless device to an idle or inactive state;
transmit an indication to a second network node in the second cell group that the wireless device will transition to an idle or inactive state; and
transmit an indication to the wireless device to transition to an idle or inactive state, the indication comprising an operational mode associated with the second cell group.

32. The network node of claim 31, the processing circuitry further operable to receive from the second network node an operational mode associated with the second cell group.

33. The network node of claim 29, wherein the wireless device is operating in dual connectivity with the first cell group and the second cell group, and the first cell group comprises a master cell group and the second cell group comprises a secondary cell group.

34. The network node of claim 29, wherein the wireless device is operating in dual connectivity with the first cell group and the second cell group, and the first cell group comprises a secondary cell group and the second cell group comprises a mater cell group.
